(19) United States
(12) Patent Application Publication
(10) Pub. No.: US 2012/0082324 A1
(43) Pub. Date: Apr. 5, 2012

(54) VIBRATION EARPHONE

(76) Inventor: Seong Sik Choi, Icheon-si (KR)

(21) Appl. No.: 13/377,335

(22) PCT Filed: Mar. 2, 2010
(86) PCT No.: PCT/KR10/01293

§ 371 Date: Dec. 9, 2011

(30) Foreign Application Priority Data
Jun. 10, 2009 (KR) 10-2009-0051673

(51) Int. Cl. H04R 1/10

(52) U.S. Cl. 381/151

(57) ABSTRACT

The present invention relates to a vibration earphone that improves the efficiency of sound output from the earphone by outputting vibrations for the high sound frequency range through a mastoid and by simultaneously outputting vibrations for the low frequency range through a cylindrical low sound transmitting member. The vibration earphone comprises a vibration member for outputting sound through vibrations and including a face plate, a voice coil, a basket with a magnet coupled thereto, and a cover; the low sound transmitting member housing the vibration member therein, for outputting vibrations for low sound through an external wall inside an ear; and a mastoid for outputting vibrations for the high sound frequency range generated from the face plate through a projection passing through the low sound transmitting member and inserted in and coupled to a hole defined in a central portion of the face plate of the vibration member.

### CROSS-REFERENCE TO RELATED APPLICATIONS

This application is a national phase of PCT International Patent Application No. PCT/KR2010/001293, filed Mar. 2, 2010, which claims the benefit of Korean Patent Application No. 10-2009-0051673, filed Jun. 10, 2009, in the Korean Intellectual Property Office, the disclosures of which are incorporated herein by reference.

### BACKGROUND OF THE INVENTION

1. Field of the Invention

The present invention relates to a vibration earphone that improves the efficiency of sound output from the earphone by outputting vibrations for the high sound frequency range through a mastoid and by simultaneously outputting vibrations for the low frequency range through a cylindrical low sound transmitting member.

2. Description of the Related Art

In general, sound heard via a human's ears is transmitted in the air though waves, and the sound transmitted to the ears vibrates air particles to make an eardrum resonate.

Namely, the sound enters into an external auditory to vibrate the eardrum, and the auditory organ transmits the sound to the human's brain, such that the human can hear.

Usually a human can hear sound of 20 Hz-20,000 Hz, and preferably can hear sound of 125 Hz-8,000 Hz, so called conversational range, comfortably. The human usually uses sound of 500 Hz-2,000 Hz for conversation.

A human can hear all the sound of 20 Hz-20,000 Hz normally, however, hearing-impaired people, such as deaf people, prebycusia people, occupational hearing-loss people and the like, cannot hear all or specific frequency range of sound.

For helping the hearing-impaired people or reducing the damage of eardrum, the conventional osteophony earphone is disclosed in Korean Patent Application No. 2006-57123.

FIG. 1 is an exploded perspective view of the conventional osteophony earphone, and FIG. 2 is a cross sectional view of the conventional osteophony earphone.

As shown in FIGS. 1 and 2, the conventional osteophony earphone 100 comprises a disc-shaped lower cover 110, a hollow cylindrical case 120 opened at top and bottom ends to be coupled to the lower cover 110, a steel core 130 attached on the lower cover 110 in the case 120, a voice coil 140 positioned around the steel core 130 to convert electric signals into vibration signals, a magnet 150 positioned around the voice coil 140 to amplify the vibration signals, a vibration metal ring 160 positioned on the magnet 150 to be coupled to the outer side of the voice coil 140, a lower mastoid 170 coupled to the top of the voice coil 140, a vibration plate 180 coupled to the top of the lower mastoid 170, and a upper mastoid 190 coupled to the lower mastoid 170 and the vibration plate 180.

In the conventional osteophony earphone 100, when electric sound signals is transmitted to the voice coil 140, the voice coil 140 vibrates up and down by the forces of attraction and repulsion with the magnet 150, and the generated vibrations get amplified by the metal ring 160 to be transmitted to the lower mastoid 170.

By the vibration plate 180, the vibrations of the lower mastoid 170 increase vertically and maximally, and the maximized vibrations eventually output high frequency sound to the human's head, via the upper mastoid 190.

### SUMMARY OF THE INVENTION

However, the conventional osteophony earphone makes the mastoid vibrate only at the center of the earphone to output high frequency range of sound, such that the sound can be heard only around the center of the earphone. Since the sound is transmitted very weakly at the outer side of the ear, users using the earphone hear substantially high sound without surround effect.

Moreover, the usual earphone generates high sound at the center where the coil is positioned and low sound at the outer side through the diaphragm; however, the diaphragm of the usual earphone is too small to generate sufficient low sound.

To overcome the above problems, the present invention provides a vibration earphone which can output high sound vibrations toward the eardrum and simultaneously output low sound (about 40% of whole sound) to the wall of the external auditory through a cylindrical low sound transmitting member, so as to improve the efficiency of sound output from the earphone.

According to one exemplary embodiment of this invention, an vibration earphone 200 generating sound through vibration comprises a vibration member 210 including a face plate 211, a voice coil 212, a basket 213 with magnet coupled thereto, and a cover 217, to generate sound using vibrations, a low sound transmitting member 220 housing the vibration member 210 therein to output vibrations for low sound through an external wall inside an ear, and a mastoid 230 including a projection 231 passing through the low sound transmitting member 220 to be inserted in and coupled to a hole defined in a central portion of the face plate 211 of the vibration member 210, the projection 231 transmitting high sound generated from the face plate 211.

Preferably, the low sound transmitting member 220 may further house the cover 217 of the vibration member 210.

More preferably, the mastoid 230 may output high sound toward an eardrum, and the low sound transmitting member 220 may output low sound to the external wall inside the ear.

The vibration earphone of this invention can output high sound of vibrations toward the eardrum, and simultaneously output low sound vibrations to transmit it to the internal ear via skin and bone, through a cylindrical low sound transmitting member housing the vibration member, so as to improve the efficiency of sound output from the earphone and reduce the damage of the eardrum.

In contrast to the usual earphone which makes user's ear ring due to bumping of the diaphragm, the earphone of this invention can overcome this problem.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of the conventional osteophony earphone.

FIG. 2 is a cross sectional view of the conventional osteophony earphone,

FIG. 3 is an exploded perspective view illustrating a vibration earphone according to the present invention, and

FIG. 4 is a cross sectional view illustrating the assembled vibration earphone according to the present invention.

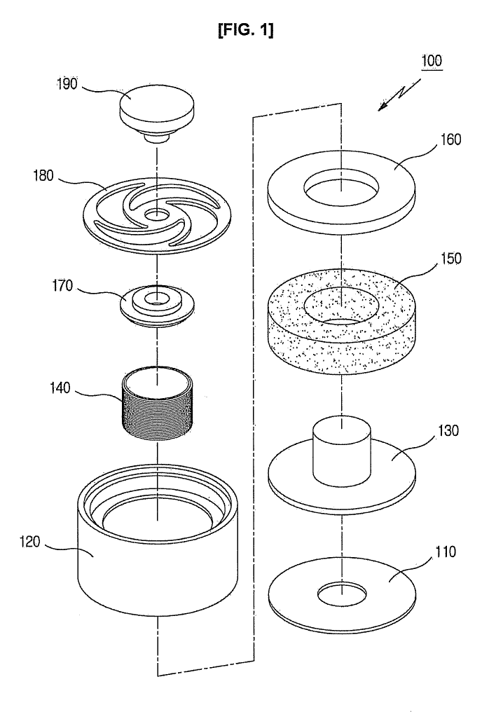

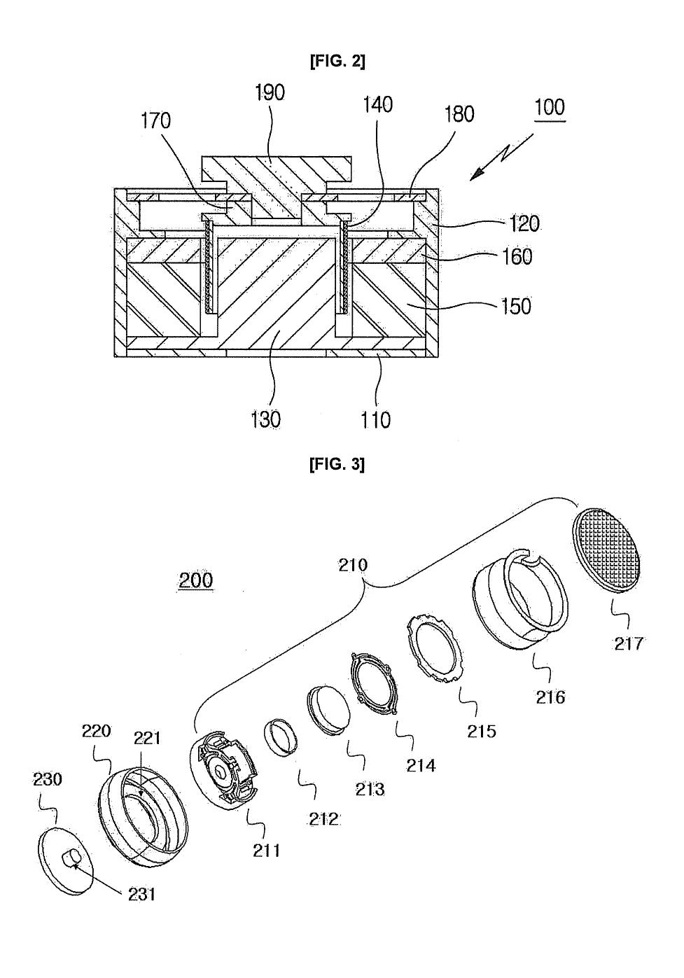

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

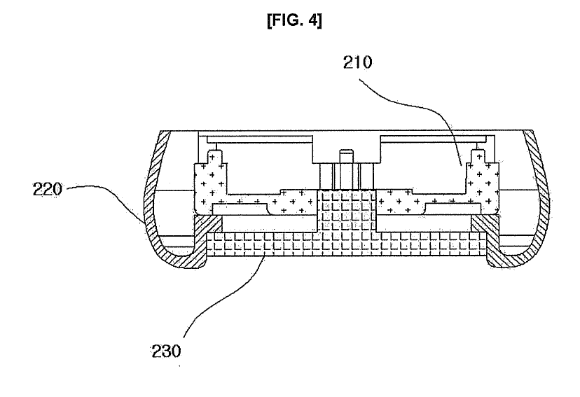

FIG. 3 is an exploded perspective view illustrating a vibration earphone according to the present invention, and FIG. 4 is a cross sectional view illustrating the assembled vibration earphone according to the present invention.

Referring to FIGS. 3 and 4, a vibration earphone 200 according to one embodiment of the present invention comprises a vibration member 210, a low sound transmitting member 220 and a mastoid 230.

Here, the vibration member 210 may be one of the conventional vibrating modules for generating sound, for example, may comprise a face plate 211, a voice coil 212, a basket 213 with magnet coupled thereto, a vibrating flat spring 214, a PCB substrate 215, a case 216 and a cover 217.

Particularly, the face plate 211 is a means for transmitting sound generated from vibrations of the vibration earphone 200, into the ear, which may be formed using soft material like silicone and may include a hole formed in its central portion to transmit sound smoothly into the ear.

The face plate 211 may form a whole body of the vibration member 210, instead of the case 216 described as below.

The voice coil 212 may be installed inside the face plate 211 and adhered by thermostable adhesion, so as to drive the vibration earphone 200 when receiving electrical sound signals inputted via the PCB substrate 215.

Namely, the voice coil 212 may vibrate in a predetermined frequency range by current intense and magnetic property.

The basket 213 is installed over the voice coil 212 and it has a magnet (not shown) therein to prevent reducing of sound and to guide air flow in one direction.

The basket 213 is shaped in a hollow cylinder of which one end is closed, to contain the magnet. The basket 213 and the magnet are spatially separated to form a space, in which the voice coil 212 is located between the basket 213 and the magnet.

The magnet may be formed in a shape of a hollow cylinder, to be attached to the metal basket 213 or be bound to the basket.

Although the magnet is shaped in a hollow cylinder in this embodiment, the magnet may be formed in various shapes with or without a hole in its center.

The vibrating flat spring 214 may have a central hole which is engaged with the basket 213, to convert part of the sound generated from the voice coil 212 to soft vibration.

The PCB substrate 215 is composed with electric components to output sound in the vibration earphone 200, in which the PCB substrate 215 may be connected with the voice coil 212 via anode and cathode wires (not shown).

The case 216 may house the face plate 211, the voice coil 212, the basket 213 coupled with the magnet, the vibrating flat spring 214 and the PCB substrate 215 to protect them.

In this instance, the case 216 of this embodiment contains the vibration member 210 for protection; however, the face plate 211 may contain other elements in it.

The cover 217 is located at the rear side of the case 216 to reflect sound toward the face plate 211.

On the other hand, the low sound transmitting member 220 is shaped in a hollow cylinder having a hole at its center and an inner division wall (one side of the inner wall contains the vibration member 210 which is assembled with the face plate 211, the voice coil 212, the basket 213, the vibrating flat spring 214, the PCB substrate 215, the case 216 and the cover 217, so as to transmit low frequency range of sound.

The low sound transmitting member 220 may be formed using soft material like silicone, to wrap the cover 217 of the vibration member 210 to closely contact with the inside of the ear.

The mastoid 230 may be formed in a cap shape which has a projection 231 protruding at its center, to be positioned on the inner wall 221, opposite to the low sound transmitting member 220. The projection 231 passes through the hole of the inner wall of the low sound transmitting member 220 to be inserted in and coupled to the face plate 211, such that the projection 231 transmits high sound from the face plate 211 to the ear.

According to the this embodiment, the vibration earphone 200 outputs high sound (about 60% of the whole sound) through the mastoid 230 into the ear and low sound (about 40% of the whole sound) through the low sound transmitting member 220, reducing the damage of the eardrum and providing vivid sound.

Hereinafter, described is an operating mechanism of the vibration earphone 200 according to this invention.

At first, via the anode and cathode wires of the PCB substrate 215 provides electric sound signals to the voice coil 212.

And then, the electric magnetic force of the voice coil 212 mutually reacts with a magnetic field formed by the magnet in the basket 213. According to the forces of attraction and repulsion, the voice coil 212 and the magnet may mutually vibrate.

The sounds and vibrations from the voice coil 212 may be transmitted to the neighboring face plate 211.

Simultaneously, the vibrating flat spring 214 vibrates with the magnet to convert vibrations softly.

The vibrations transmitted to the face plate 211 travel to the mastoid 230 to be outputted in high frequency range of sound.

Namely, although the description of the present embodiment discloses one example of vibration earphones, the subject features of this invention may be applied to other devices, for example louder speakers, ostoephony speakers or other speakers for electric devices.

Although a few embodiments of the present invention have been shown and described, it would be appreciated by those skilled in the art that changes may be made in this embodiment without departing from the principles and spirit of the invention, the scope of which is defined in the claims and their equivalents.

1. An vibration earphone generating sound through vibration comprising:
a vibration member including a face plate 211, a voice coil 212, a basket 213 with magnet coupled thereto, and a cover 217 to generate sound using vibrations;
a low sound transmitting member 220 housing the vibration member 210 therein to output vibrations for low sound through an external wall inside an ear; and
a mastoid 230 including a projection 231 passing through the low sound transmitting member 220 to be inserted in and coupled to a hole defined in a central portion of the face plate 211 of the vibration member 210, the projection 231 transmitting high sound generated from the face plate 211,
wherein the low sound transmitting member which is formed in a cylindrical shape includes an inner wall with a central hole, so that the low sound transmitting member houses the vibration member 210 in one side of the inner wall for outputting low sound to the external wall inside the ear, and
wherein the vibration member 210 outputs high sound toward an eardrum through the projection 231 of the mastoid 230 located on the other side of the inner wall 221 of the low sound transmitting member 220.

2. The vibration earphone of claim 1, wherein the low sound transmitting member 220 further houses the cover 217 of the vibration member 210.
